(19) United States
(12) Patent Application Publication
(10) Pub. No.: US 2020/0068852 A1
(43) Pub. Date: Mar. 5, 2020

(54) Animal Caretaking System with an Animal-Mounted Audio Player Device

(71) Applicants: Sheldon Ramsay, Berkeley, CA (US); Craig Janik, Palo Alto, CA (US)

(72) Inventors: Sheldon Ramsay, Berkeley, CA (US); Craig Janik, Palo Alto, CA (US)

(73) Assignee: Mr. Sheldon Ramsay, Berkeley, CA (US)

(21) Appl. No.: 16/558,317

(22) Filed: Sep. 3, 2019

Related U.S. Application Data
(60) Provisional application No. 62/725,757, filed on Aug. 31, 2018.
(60) Provisional application No. 62/725,774, filed on Aug. 31, 2018.

(51) Int. Cl. A01K 27/00; G06F 3/16; H04R 1/02; H04R 3/00; A01K 15/00; A01K 29/00

(52) U.S. Cl. CPC A01K 27/009; G06F 3/165; H04R 1/025; H04R 2420/07; A01K 15/00; A01K 29/005; H04R 3/00

(57) ABSTRACT

A system for animal caretaking with an animal-mounted audio playback device, a sensing device for sensing the proximity of the playback device with respect to a specific location, a smartphone with a GPS receiver, one or more wireless communication systems connecting the playback device, the location sensing device, and the smartphone, and a smartphone app with a user interface for specifying various parameters for controlling the playback device such that when the caretaker moves a specified distance from the location of the animal, a sound chosen by the caretaker will be emitted from the playback device, and when the animal moves within a specified distance from the location sensing device, a deterrent sound is emitted from the playback device.

### CROSS-REFERENCE TO RELATED APPLICATIONS

This application claims the benefit of U.S. Provisional Application No. 62/725,757, filed Aug. 31, 2018, entitled Audio Playback System for Canines and Other Animals, and U.S. Provisional Application No. 62/725,774, filed Aug. 31, 2018, entitled Containment System for Canines and Other Animals.

### NON-PATENT LITERATURE DOCUMENTS

L. R. Kogan, et al, Journal of Veterinary Behavior, “Behavioral effects of auditory stimulation on kenneled dogs” (2012).

### BACKGROUND OF THE INVENTION

The bond between dog owners and their pets is mutually beneficial and rewarding. Owners put great effort into caretaking including selection of food, providing attention, and exercise, all to insure the overall physical and emotional health and wellbeing of their pets. In the course of daily life, pets are regularly left alone due to responsibilities of the owner. Dogs in particular, being social animals, are often stressed by the departure of caretakers, and evidence of this can be observed by the excitation of the animals upon both caretaker departure and return.

At the same time, while absent from certain areas of the home or upon departing the home premises, many caretakers have a desire to contain their pets to preferred areas. For example many caretakers want to contain their pets, that is, prohibit pets from accessing certain areas, rooms, or furniture such as beds.

The acute hearing of canines is widely known, and although dogs, and pets in general, have been incidentally exposed to audio entertainment since the invention of recorded sound, only recently has there been interest in the effect of music on canine behavior. There has been an effort to ameliorate pet's stress with the use of sound. A 2012 study published in the Journal of Veterinary Behavior of the effects of playing music for kenneled dogs suggested that playing classical music may mitigate stress. This study partially replicated the results of previous studies.

Likewise with regard to audio, it is widely accepted that dogs specifically have a strong aversion to sound at certain frequencies and this aversion can be used to control the location of the animal.

There have been inventions that mount speakers on animals, specifically dogs. U.S. Pat. No. 8,539,913 by Caputo et al shows various embodiments for mounting at least two speakers on a canine, including in a collar, in a hood, and in a body harness. Caputo's invention teaches that a minimum of two speakers are required, one to be located in close proximity to each of the dog's ears. It should be noted that the research showing the calming effect of music on dogs does not specify the proximate speaker location described in Caputo. Additionally, the Caputo collar embodiment requires that the conventional collar be replaced by a custom “tubular” collar that contains the required electronics. The integration of the technology into a collar poses problems for sizing and fit. Furthermore Caputo does not describe any use for containment purposes.

What is required is a comprehensive caretaking system for canines and other animals that includes an animal-mounted audio playback device that attaches to an existing collar. The caretaking system should also provide a convenient interface to select, schedule, and automate the playback of audio content, for example when the owner is absent and/or based on the state of the animal. Further, the caretaking system should be configured to emit soothing and calming sounds as well as deterrent sounds based on the location of the animal.

### SUMMARY OF THE INVENTION

The present invention solves the aforementioned problems by providing a system for dog owners to provide their pets with audible content for various purposes such as entertainment, recreation, pacification, relaxation, and as a soporific, as well as a deterrent for the purpose of controlling the location of the animal. The caretaking system includes an animal-mounted audio playback device, a proximity sensing device configured to interact with the audio playback device, a caretaker location sensing device, and a general purpose setup and programming device, all connected via a wireless communication network. The setup and programming device includes a software application with a user interface that is used to setup and program various control parameters associated with the caretaking system including the selection, scheduling, and automating of playback of soothing and deterrent audio based on the location of the caretaker and the location and state of the animal.

### Definitions

Deterrent Sound is defined here in the context of its effect generally on animals, but also in the specific case of a canine, that is experienced as unpleasant or otherwise causes the canine to alter its behavior or location. Conventional deterrent sounds for canines are generally tones above 25 kHz and between 110 and 130 decibels and will cause the canine to halt their action or make movements to avoid the sound. Novel canine deterrent sounds include a recording of the canine owner's voice, a voice with a stem tone, or other spoken word recordings.

Off-Limits Area is defined as a spatial zone where a specific animal or animals are to be deterred from entering into or onto.

### LIST OF DRAWING FIGURES

FIG. 1. is an illustration of an animal caretaking system for animals.

FIG. 2. is an illustration of the base station.

FIG. 3A. is an illustration showing the base station dock.

FIG. 3B. is an illustration showing a collar unit docked to the base station dock.

FIG. 4. is a front view of the collar unit.

FIG. 5. is an exploded view of the collar unit.

FIG. 6. is a block diagram of the base station electronics.

FIG. 7. is a block diagram of the collar unit electronics.

FIG. 8. is a rear view of the collar unit.

FIG. 9. is a view of the collar unit attached to the dog collar.

FIG. 10. is a network diagram of a system with base station with storage and control functionality.

FIG. 11. is a network diagram of a system with local control and content store on a network attached storage device.

FIG. 12. is a network diagram of a system with content and control in the cloud and with optional content and control located on a local network attached storage device.

FIG. 13. shows a smartphone control app user interface for scheduling the activation and deactivation of content playback on a collar unit.

FIG. 14. shows a smartphone control app user interface for setting up a home base location.

FIG. 15. shows a collar unit that includes dual microphones.

FIG. 16. is an illustration of a proximity sensor module.

FIG. 17. is a hardware block diagram of the sensor module.

FIG. 18. is a hardware block diagram of a sensor module with Wifi and a speaker.

FIG. 19. is a machine vision containment device.

FIG. 20. is a smartphone showing an app interface for creating off-limits boundaries.

FIG. 21. is a network diagram of animal caretaking system that incorporates a machine vision containment device.

### DESCRIPTION OF THE EMBODIMENTS

First the hardware components of the animal caretaking system for canines 1 will be described. Then the function of system 1 will be described.

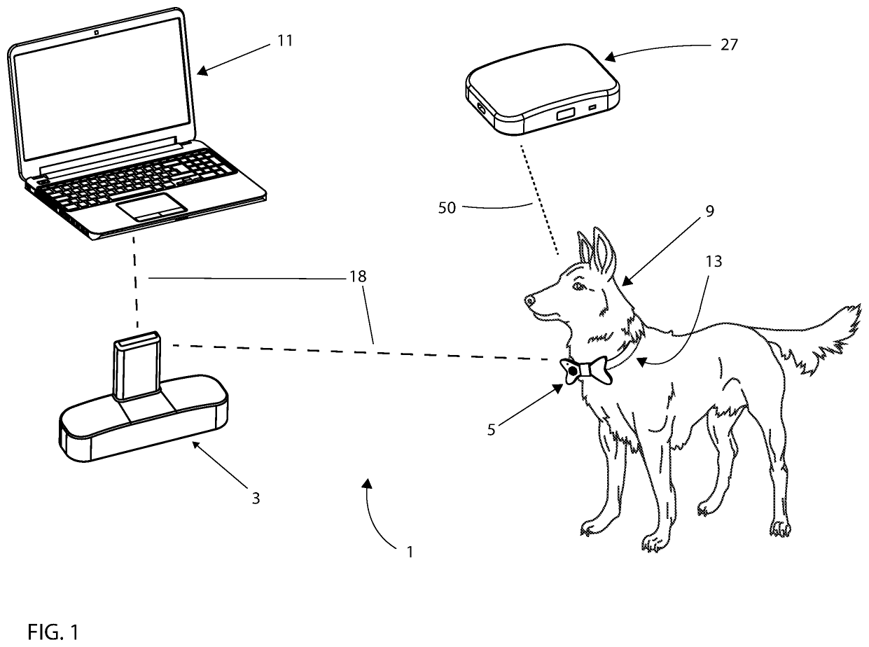

FIG. 1 shows the elements in an embodiment of animal caretaking system 1 including a wireless base station 3, a Personal Computer (hereafter PC) 11 connected via a wireless network 18 to the base station 3, a proximity sensing module 27, and a canine 9 wearing a collar unit 5 that is attached to a canine collar 13.

### Description of the Base Station Device

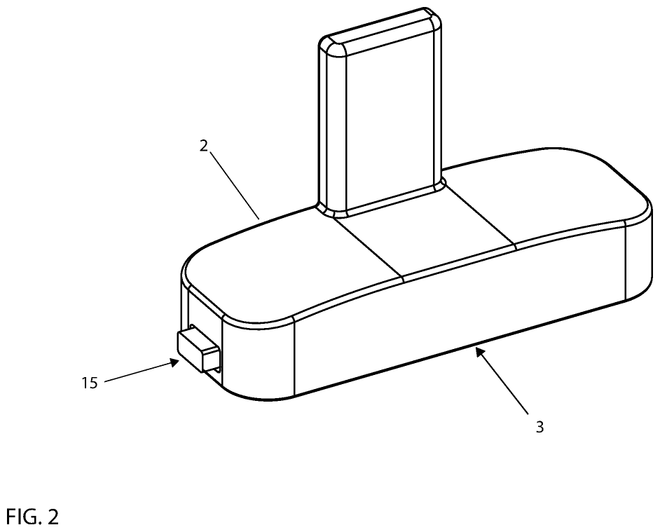

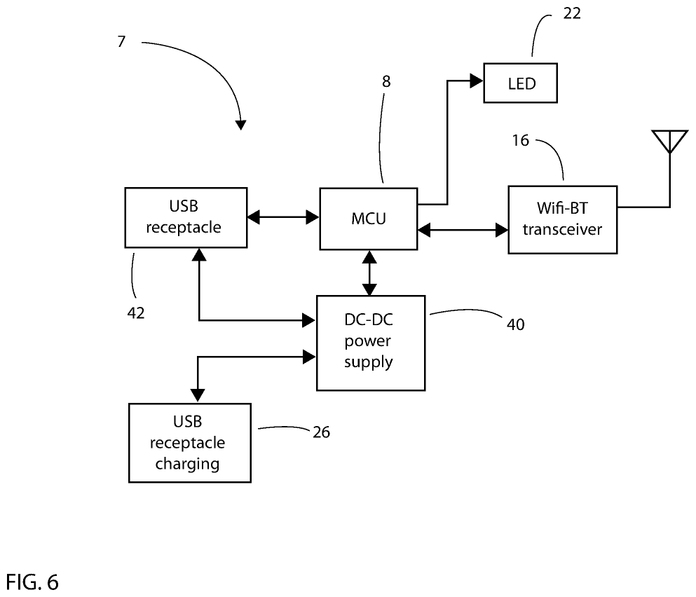

FIG. 2 is a view of a base station 3 showing an enclosure 2, and a USB receptacle with a USB flash drive 15 plugged in. Enclosure 2 contains the electronic subsystem (also shown in FIG. 6) comprised of a microcontroller unit (MCU) 8, a DC-DC power supply 40, flash memory, an indication LED 22, and a Wifi transceiver module 16. Base station 3 is powered by an AC adapter, not shown. The further details of base station 3 will be well known to one skilled in the art of wireless networking and digital media and will not be described in detail.

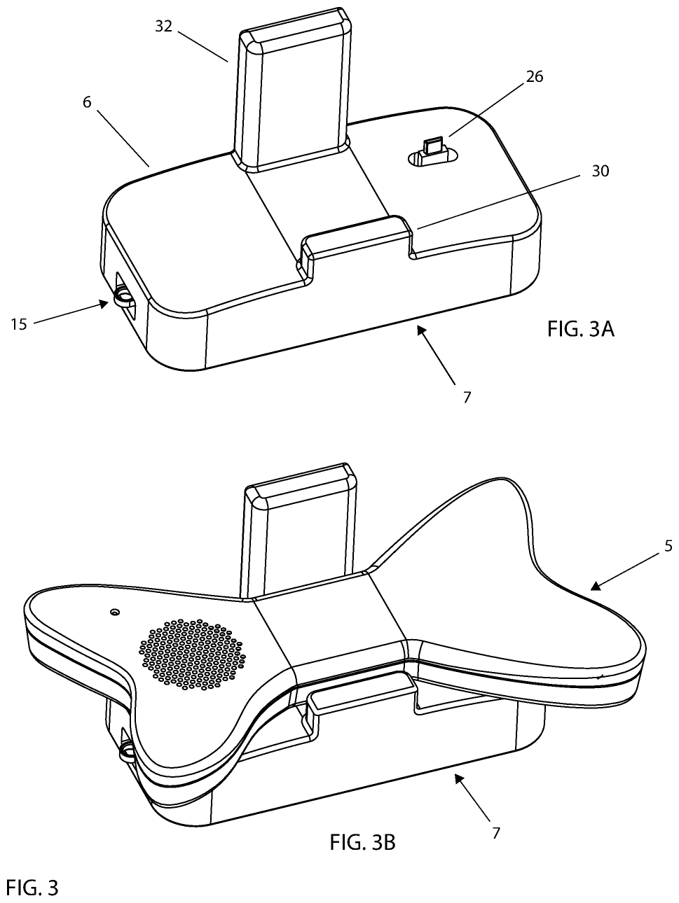

In another embodiment shown in FIG. 3, a base station dock 7 includes the components in base station 3, but also functions as a charging dock for collar unit 5. FIG. 3A shows that base station dock 7 includes a vertically mounted USB micro A/B connector 26 that connects to the USB connector 108 on collar unit 5 for charging collar unit 5 when docked. A front guide 30 is molded into the enclosure and helps guide collar 5 onto dock 7. Base station dock 7 includes a DC-to-DC conversion circuit that provides 5V and 500 milliamps to the 5V USB pin for charging collar unit 5. FIG. 3B shows collar unit 5 docked for charging.

In another embodiment base station includes an Ethernet network transceiver functionally connected to microcontroller for connecting to an internet router.

### Description of the Collar Unit Device

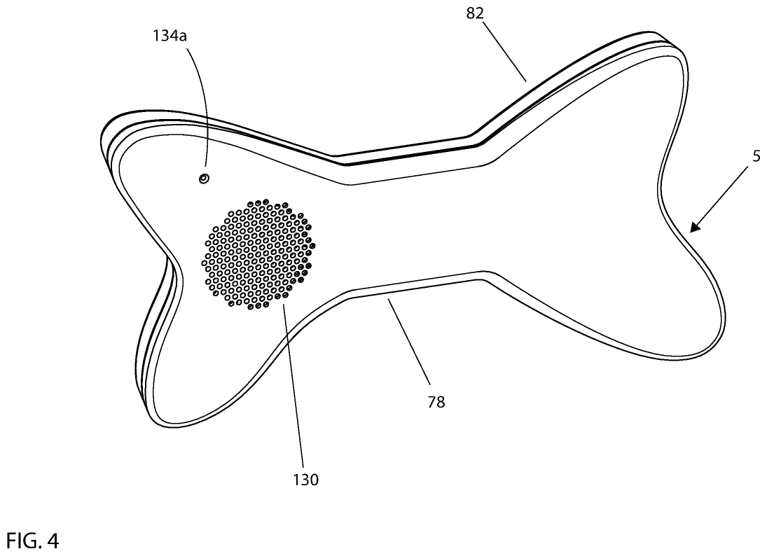

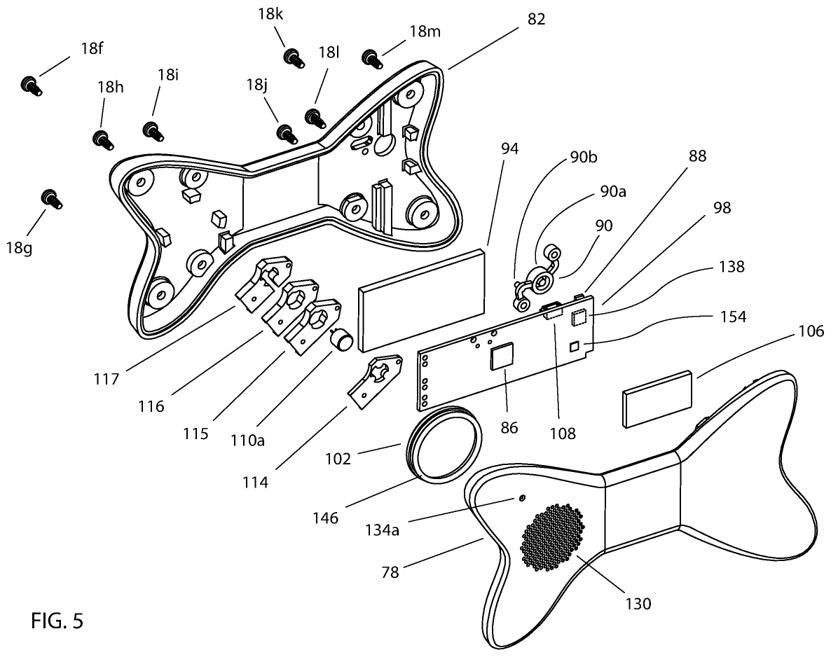

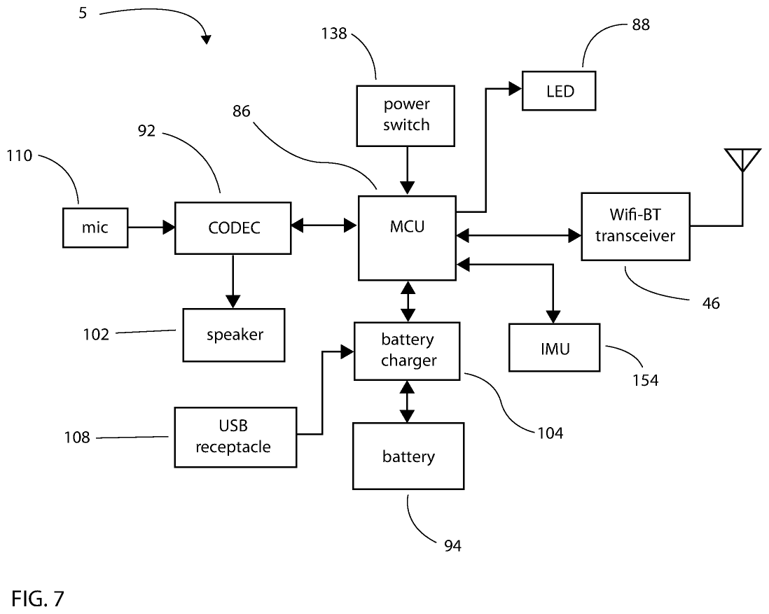

FIG. 4 shows a collar unit 5 that includes a collar unit front enclosure 78 and a collar unit rear enclosure 82. Referring now to FIG. 5, an exploded view of collar unit 5, and FIG. 7 a block diagram of collar unit 5 electronics, the enclosed components include a printed circuit board 98 that functionally connects a microcontroller 86, an LED 88, a wireless communication module 46, a CODEC IC 92, battery charger-power supply IC 104, a battery 94, a microphone 110, a speaker 102, a vertical USB micro A/B connector 108, a momentary power switch 138, and various other electrical components that are not shown but that would be obvious to one skilled in design of wireless audio devices.

In one embodiment microcontroller 86 is part number CY8C5868LTI-LP038, manufactured by Cypress Semiconductor of San Jose, Calif. In one embodiment LED 88 includes integral blue, green, and red elements. In one or more embodiments collar unit 5 includes a real time clock subsystem.

In one embodiment wireless communication module 46 is a Wifi-Bluetooth transceiver module model number NINA-W101 manufactured by u-blox, of Thalwil, Switzerland. The NINA-W101 is a pre-certified module that incorporates an ESP32 2.4 GHz Wi-Fi-and-Bluetooth combo chip designed with TSMC (Taiwan Semiconductor Manufacturing Corporation) ultra-low-power 40 nm integrated circuit feature size.

In another embodiment collar unit 5 electronics is comprised of a System-on-Chip (SoC) that integrates two processor cores, a sound input and output processing subsystem (CODEC), and a Bluetooth 5.0 radio-frequency communication subsystem. In one embodiment, SoC is a PSoC® 63 with BLE device manufactured by Cypress Semiconductor Corporation of San Jose, Calif. One SoC processor core is used to run system code.

FIG. 7 is a block diagram of the collar unit 5 electronics. Codec IC 92 includes a mic 110 pre-amp, a DAC, and a power amplifier. In one embodiment codec 92 is part number TLC320AIC3101 manufactured by Texas Instruments of Dallas, Tex.

In one embodiment battery charger-power supply IC 104 is part number MCP73831/2, manufactured by Microchip.

FIG. 5 shows an o-ring seal 146 configured axially aligned with speaker 102. When collar unit 5 is fully assembled, rear enclosure 82 presses against the rear side of speaker 102, which is in turn compressed against o-ring seal 146, which is in turn compressed against front enclosure 78, creating an acoustic seal that insures that a substantial amount of acoustic energy is directed externally through a plurality of openings in front enclosure 78 constituting a speaker grill 130.

FIG. 5 also shows an exploded microphone assembly that includes microphone 110, and a stack of a mic support 114, a mic support 115, a mic support 116, and a mic support 117. Each of mic support 114, 115, 116, and 117 is die-cut from ultra-soft silicone foam sheet material. In fully assembled collar unit 5 mic support part 114, 115, 116, and 117 are compressed together to mechanically isolate microphone 110. A mic port hole 134a is molded into front enclosure 78 and is positioned above microphone 110.

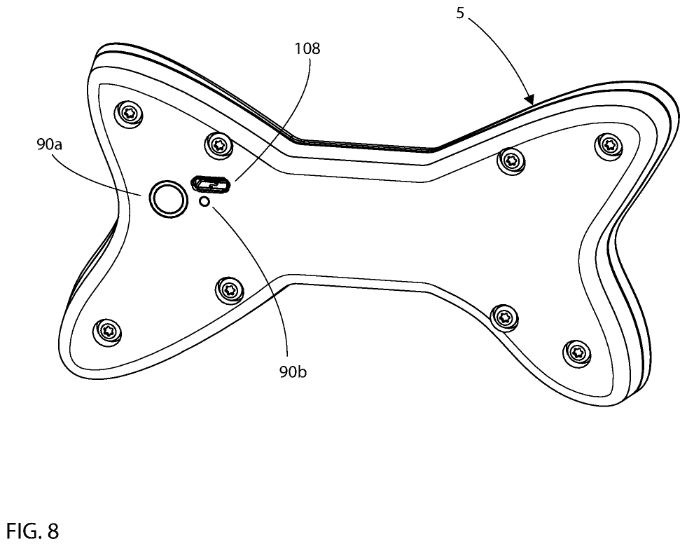

FIG. 5 shows an injection-molded plastic button-lightpipe 90 that is fastened to rear enclosure 82. Button-lightpipe 90 includes thin plastic flexures that allow a large circular power button 90a to translate slightly when pressed, thereby activating momentary switch 138. Button-lightpipe 90 plastic material is transparent, therefore button 90 also functions as a lightpipe. FIG. 8, a rear view of collar unit 5, shows that power button 90a, is exposed through a large circular hole in, and is flush with the surface of, rear enclosure 82. A lightpipe portion 90b that is a small cylindrical portion of button-lightpipe 90, is exposed through a small circular hole in, and is flush with the surface of, rear enclosure 82. The internal end of cylindrical lightpipe 90b is apositioned against LED 88, therefore lightpipe 90b functions as a lightpipe user interface feature.

Referring again to FIG. 5, a plurality of plastic self-threading screws 18f, g, h, i, j, k, l, and m fasten front enclosure 78 to rear enclosure 82, enclosing and constraining the internal components.

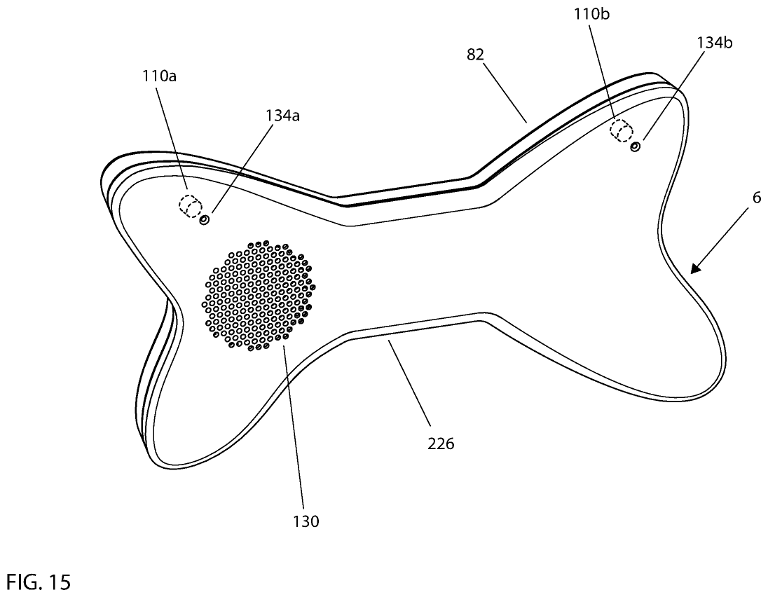

FIG. 15 shows collar unit 6, an embodiment that includes a dual microphone array with SoC configured for beamforming, which is a noise suppression method. The dual mic array is comprised of microphone 110a and a microphone 110b. A collar front enclosure 226 includes mic port 134a and a mic port 134b. Mic 134a and 134b are both mounted within a plurality of mic support components as shown in FIG. 5. A DSP audio framework that is an executable application runs on one of the two SoC cores in the embodiment that includes the PSoC® 63 with BLE device. In one embodiment audio framework is provided by DSP Concepts of Santa Clara, Calif.

The beamforming noise suppression function is controllable by a user interface included in handler smartphone app which includes a UI widget for enabling and disabling noise suppression.

### Collar Unit Software

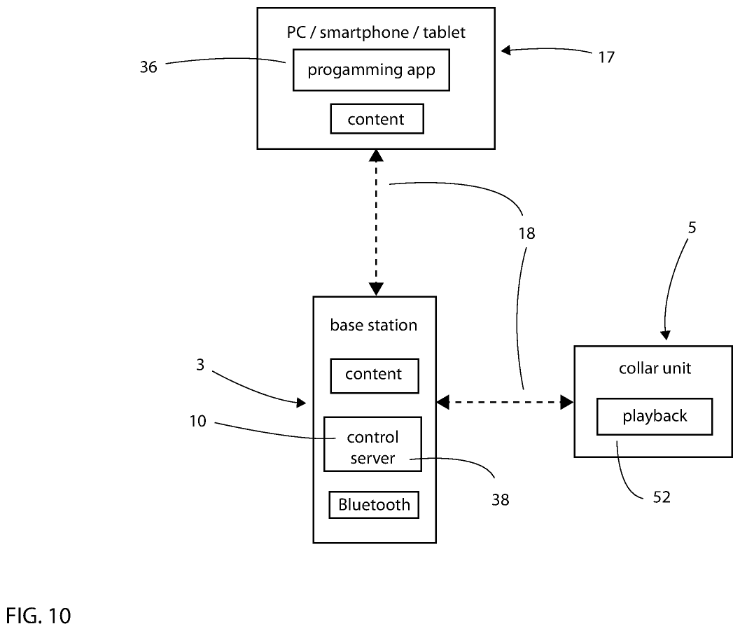

Referring now to FIG. 10, in one embodiment collar unit 5 is a thin client and includes a content player software application 52 running on microcontroller 86 that receives, decodes, amplifies, and plays back audio content from a network audio stream.

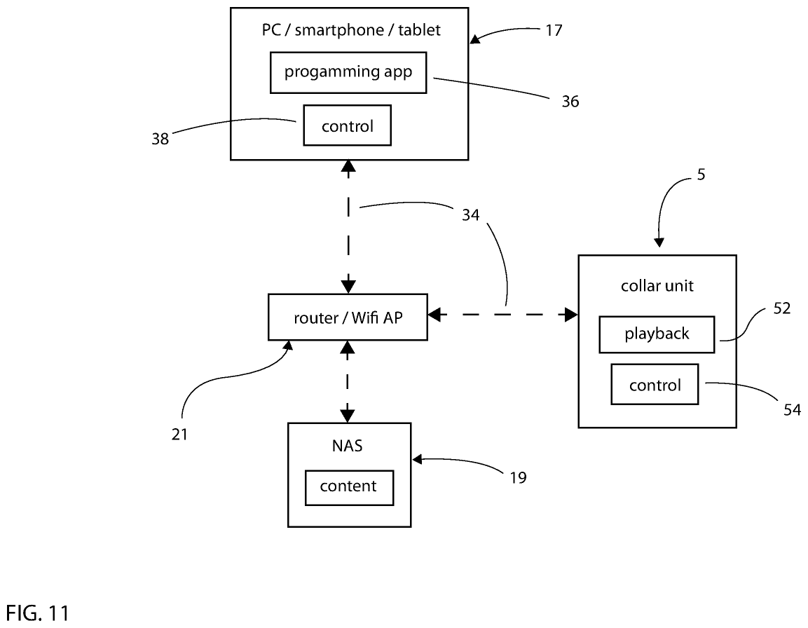

In another embodiment shown in FIG. 11 collar unit 5 includes a collar control software application 54 that controls the playback of audio according to setup and programming parameters created by a setup and programming application 36 running on a general purpose computing device 17. The parameters are transferred to collar unit 5 via a wireless link 34 and are stored in non-volatile memory integral to microcontroller 86 collar unit 5 memory. The parameters include, but are not limited to: storage of audio content, location of content stored on the network or cloud, storage of playback scheduling data, storage of playback volume settings. Collar control software app 54 includes subroutines to schedule the start and stop of streaming of content from the content network location based on the parameters.

### Description of the Setup and Programming App

In one embodiment a playback setup and programming software application 36 includes the following functions and features:
Selection of audio content from an existing store of digital audio files.
Copying and storing selected audio content in non-volatile (flash) memory on base station 3.
Scheduling playback sessions which include the date, start time, stop time, and volume of the playback of the stored audio content.
Storing the playback session data on base station 3.
Storing the playback session data on collar unit 5.
Volume control of audio played on collar unit 5.

In another embodiment programming application 36 includes the basic functions and the option to copy and store selected audio content to a network-attached storage device (hereafter NAS).

In another embodiment programming application 36 includes the basic functions and the option to select and purchase soothing audio programming that is specified to aid in the calming of canines.

Additional embodiments of programming app 36 include implementations to run on a PC, tablet, and smartphone 17.

### Description of System Network Architectures—Base Station System

The caretaking system for animals 1 may be implemented in a variety of network configurations that are described herein.

FIG. 10 shows a network embodiment that includes a base station 3, a programming application 36 running on a general purpose computing device 17, and collar unit 5. Audio content to be streamed to collar unit 5 via Bluetooth communication link 18 may reside on device 17 and/or base station 3. A base station control software application 10 runs on microcontroller 8 and includes a server application 38. Control parameters that are selected by the user are transmitted to, and are stored in memory on base station 3. Collar unit 5 plays a digital audio stream that is controlled by base station control software app 10.

### Network Attached Storage System

FIG. 11 shows a network embodiment that includes a networked-attached storage device (NAS) 19, a programming application 36 running on a general purpose programming device 17, such as a PC, smartphone, or tablet, and a collar unit 5. Audio content stored on NAS 19 is streamed to collar unit 5 via Wifi communication link 34. Control software 38 is executed from programming device 17 and/or collar unit 5.

### Cloud System

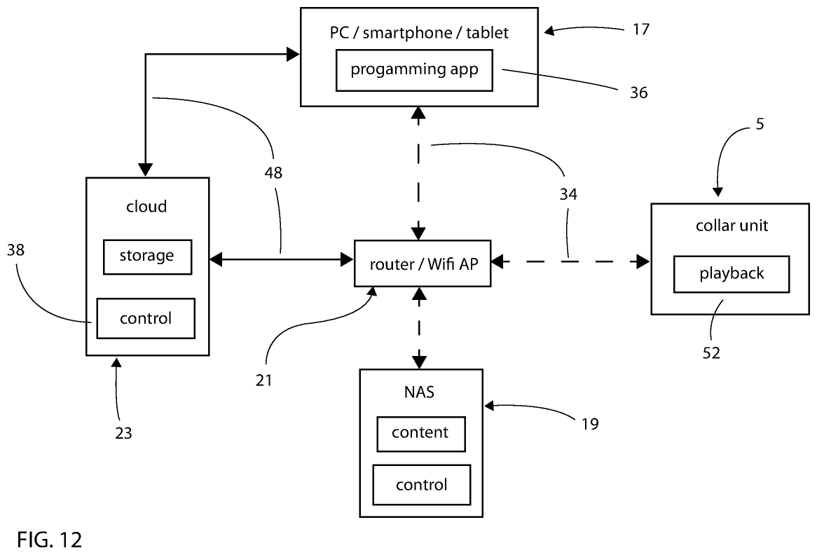

FIG. 12 shows a network embodiment that includes storage and control software 38 in a cloud server 23, a programming application 36 running on a PC, smartphone, or tablet 17, and a collar unit 5. Control software 38 will require a user to register which is defined as creating an account with authentication factors to gain access to cloud server 23 services. The communication software connecting cloud server 23 control software 38 is configured to use a websockets communication process to provide reliable two-way initiated communication between cloud server 23 and collar unit 5. FIG. 12 shows that programming device 17 is connected to cloud server 23 via a wide area connection 48 that is a cellular data connection when device 17 is located remote from the home base. However wide area connection 48 between cloud server 23 and internet t router 21 is a wired broadband connection.

### Description of the Proximity Sensor Module Device

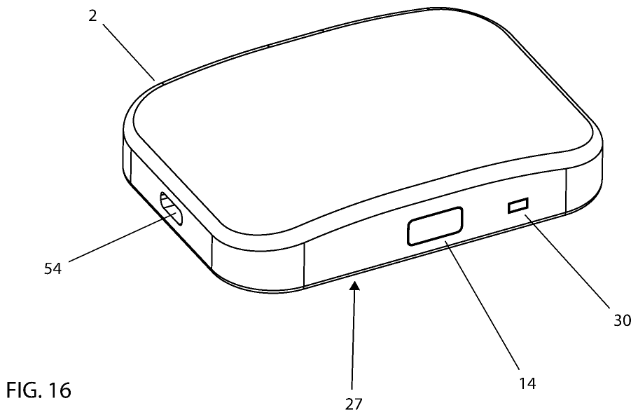

FIG. 16 is a view of proximity sensor module 27 showing a plastic molded enclosure 2, a power button 14, a status indicator LED lightpipe 30, and a USB receptacle 54 for charging. Further details of the mechanical design of sensor module 3 will not be described in detail because they would be obvious to one skilled in the design of such devices.

### Proximity Sensor Module Electronics

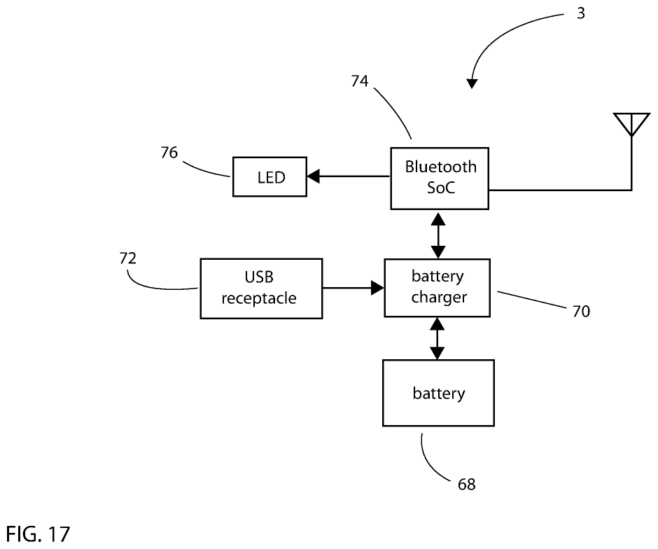

FIG. 17, a block diagram of sensor module 3, shows that sensor module 3 includes Bluetooth SoC 74, an LED 76, a battery 68, a battery charger/power supply IC 70, and a USB receptacle 72.

### Description of Devices—Powering on and Off, and Charging

Base station 3 is powered when plugged into AC power.

Collar unit 5 is powered on and off by the use of power button 90a. If collar unit 5 is powered down, pressing and holding button 90a for 4 seconds will power on collar unit 5. LED 88 will flash blue. If collar unit 5 is powered on, pressing and holding button 90a for 4 seconds will power off collar unit 5. LED 88 will flash red three times as a signal to the user the collar unit 5 is powered off.

Sensor module 27 is powered on and off by pressing and holding power button 14.

Collar unit 5 is charged by plugging one end of a USB cable into USB connector 108, and the other end of the USB cable into a 5V power source. In one embodiment collar unit 5 is charged by docking with base station dock 7.

Sensor module 3 is charged by plugging one end of a USB cable into USB connector 54, and the other end of the USB cable into a 5V power source. In another embodiment a sensor module charging station provides for mounting and charging a plurality of sensor modules 3.

### Description of Use of the System—Audio Playback for Soothing

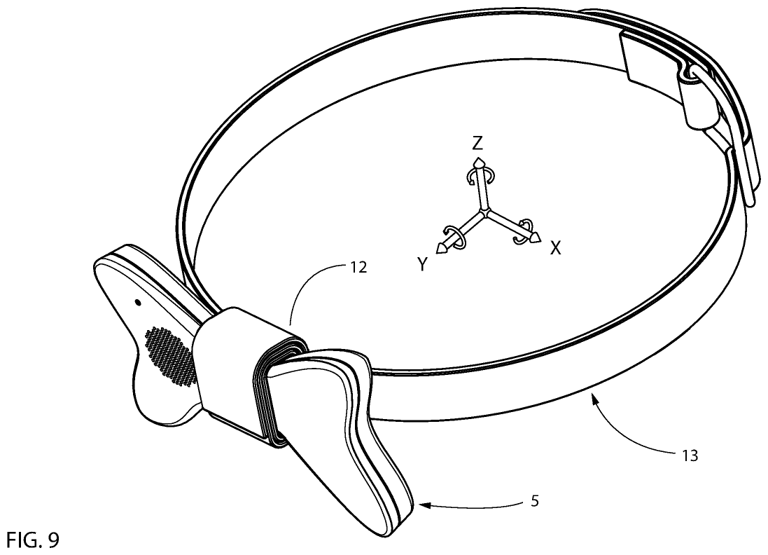

In one embodiment, collar unit 5 is attached to a dog collar 13 by use of a strap 12 as shown in FIG. 1 and FIG. 9. Strap 12 is a strip of double-sided Velcro with hooks on one side and loops on the other side. The length of strap 12 is sufficiently long to allow flexibility in the vertical location of collar unit 5 with respect to collar 13. FIG. 9 shows collar unit 5 attached to collar 13 such that the rear surface of the narrow middle section of rear enclosure 82 is apositioned against collar 13, locating collar unit 5 snug against collar 13. In this configuration, strap 12 is wrapped multiple times around collar unit 5.

Collar unit 5 is powered on by pressing collar unit 5 power button 90a until LED 50 flashes blue. Base station 3 and collar unit 5 then automatically connect via Bluetooth link 18, depicted as a dotted line in FIG. 1. When base station 3 and collar unit 5 are connected, LED 22 and LED 88 each continuously flash green.

Regardless of the network architecture, system 1 functions such that audio content is streamed to and played back by collar unit 5 based on session parameters set up by a user using programming application 36.

### Scheduled Activation of Playback

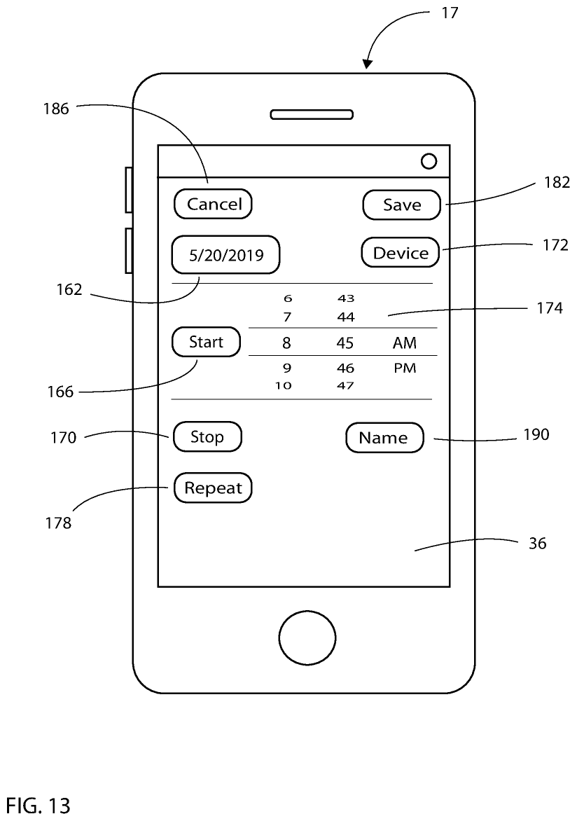

FIG. 13 shows a setup and programming app 36 user interface for scheduling the activation and deactivation of content playback on collar unit 5. The user enters scheduling mode by selecting the Schedule button widget on the app main interface. A Cancel widget 186 is used to exit scheduling mode. Selecting the Save widget 182 saves the scheduling selections to non-volatile memory. If more than one collar unit 5 is available, the Device widget 172 will be active. Selecting Device 172 will provide a list of collar units 5 for which the schedule can be associated. Selecting the Start widget 166 causes a time selection user interface 174 to appear, which is a digital vertical scrolling wheel simulation that is a common interface method for selecting from a large number of sequential items. The hour, minute, and AM/PM selection is made by swiping upward or downward on each column respectively, stopping the scroll when the desired value is in the center position. Selecting the Name widget 190 shows an additional selection for adding a text name for a schedule or for a adding a text name for a specific collar unit 5. Selection of either option shows a text entry field for entering the name. Each unique name of a collar unit is associated with the unique identifier stored in non-volatile memory in collar unit 5.

Saved schedule data constitutes playback parameters that are distributed to the software control function 38, the location of which is determined by the specific network configuration described herein.

Setup and programming app 36 also includes a software subroutine and a user interface for manually activating and deactivating playback of audio on one or more collar units 5.

In another embodiment setup and programming app 36 includes a software subroutine and a user interface for selecting a random playback mode that randomly activates and deactivates audio playback on collar unit 5 during scheduled sessions or during playback activated by other means. The length of on-playback intervals and playback intervals is randomized.

### Automated Activation of Playback Based on Location of Owner

In another embodiment playback programming app 36 includes a location monitoring function. In one embodiment that is the iOS version of the playback app 36, the Core Location App Service is used to monitor the geographic location, using GPS coordinates, of the animal caretaker's smartphone 17. Playback app 36 also includes location activation software logic configured so that when caretaker's smartphone 17 location moves beyond a specified distance, for example 200 feet from the location of the animal 9 home base location, playback app 36 sends a playback activate message to the software control function 38, the location of which is determined by the specific network configuration described herein.

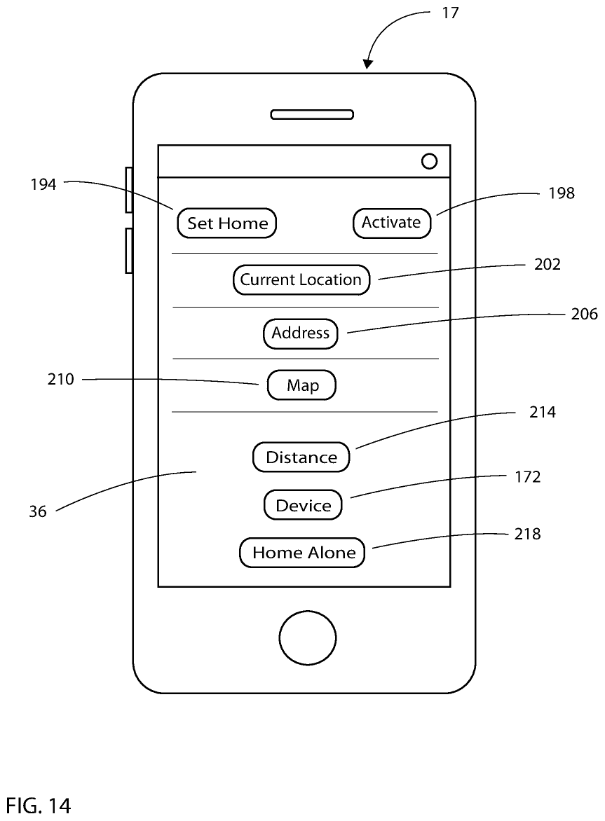

FIG. 14 shows a location activation setup user interface for a location software subroutine included in setup app 36 that includes a Set Home widget that provides an interface for selecting the animal static home base reference location (GPS coordinates in software). The options for selecting Home location are Current Location 202, Address 206, and Map 210. Selecting Current Location 202 saves the current GPS coordinates as the base location parameter. Selecting Address 206 activates a text input field for entering an address as a base location. Selecting Map 210 activates an embedded map interface that provides a means for navigating to a specific map location. Holding a selection on a spot in the map location for three seconds results in the GPS coordinates of that location being saved as the base location parameter. Selecting Device 172 widget provides an interface for associating the selected base location with a specific collar unit 5. Selecting Distance 214 activates an interface for setting the distance, in feet, between smartphone 17 and the home base coordinate that will trigger the activation of playback on collar unit 5. In the iOS app, Location must be set to Always in the Settings menu function.

In another embodiment where smartphone 17 and collar unit 5 both include Bluetooth RF capability, absence of the owner is determined by the state of Bluetooth link 18 between smartphone 17 and collar unit 5. Loss of Bluetooth link indicates the caregiver has left the home base location.

In a related embodiment a plurality of persons associated with the home base location have playback programming app 36 that includes location activation software installed on each of smartphone 17 respectively. Each person creates a home base location using app 36 interface as described herein. FIG. 14 includes a Home Alone 218 widget, the selection of which activates a Home Alone mode where audio playback is activated only when all registered persons are located away from the home base location. For example if cloud server 23 system configuration is used, the location monitoring function in each smartphone 17 sends a location_change message to cloud server 23 if the person, in possession of smartphone 17, moves substantially away from home base location. Control software 38 tracks the location status of all registered users associated with a specific base location. If all registered users have a changed location, i.e., the users have left the home base location, control software 38 activates playback on collar unit 5 with a message sent via the network.

The programming and access to various geographic map database sources are well known to software developers and will not be described in detail.

### Playback Based on Sensing the State of the Animal

In another embodiment collar unit 5 includes a motion sensor 154 that is functionally connected to microcontroller 86 which includes the requisite software routines for processing the signals output by motion sensor 154. In one embodiment motion sensor 154 is a 3-axis accelerometer. In another embodiment motion sensor 154 is an inertial measurement unit (IMU) that includes a 3-axis accelerometer, a 3-axis gyroscope, and a magnetometer is functionally connected to microcontroller 86 that includes the requisites software for processing the signals output by IMU.

Certain motion, or lack of motion, indicates various physical states of animal. FIG. 9 shows a reference coordinate system for the motion sensor 154. The orientation of accelerometer 154 in collar unit 5 combined with signal analysis would indicate that for example, a canine is likely sleeping on its left side if the motion signal output of the accelerometer of all three axes is at a low output level, and if the orientation of the X-axis accelerometer is substantially vertical. Additionally, certain combinations of motion associated with heart rate and respiration may indicate that the canine is asleep. In this case logic included in an animal state software subroutine running on microcontroller 86 on collar unit 5 ceases playback in order to conserve battery power. Likewise when accelerometer data indicates that the animal is not sleeping, playback will be activated.

### Description of Use of the System—Containment

In this description sensor module 3 and collar device 5 are powered on and are paired and connected by a Bluetooth link 50, depicted as a dotted line in FIG. 1. Collar device 5 is attached to a dog collar 13 by use of a strap 12 as shown in FIG. 1. When sensor module 3 and collar device 5 are connected, LED 62 and LED 90 each slowly and continuously flash green.

Sensor module 3 is placed on an object or at a specific location that the user intends to be an off-limits zone for animal 9. For example, sensor module 3 could be placed underneath a seat cushion on a sofa, on a bed, or in a doorway.

Sensor module 3 includes a proximity monitoring software program running on SoC 74 that includes a function for continuously periodically reading the RSSI (Received Signal Strength Indicator) value of the Bluetooth signal from collar device 5. RSSI sensing is included in the Bluetooth Low Energy software stack and will be familiar to one skilled in the art of Bluetooth software development. When the RSSI value exceeds a threshold value, monitoring software program sends a start_deterrent_sound message to collar device 5, via Bluetooth link 50. When the start_deterrent_sound message is received by collar device 5, a playback software 52 running on MCU 86 activates the software audio decoding process and a deterrent sound is emitted from speaker 102. In one embodiment the deterrent sound is a conventional sound above 25 kHz. Usually animal 9 moves in response to the deterrent sound. If animal 9 moves far enough away from sensor module 3, the RSSI value read by sensor module 3 will drop below the threshold value, and proximity monitoring program functions to send a stop_deterrent_sound message to collar device 5. Upon receipt of stop_deterrent_sound message, collar 5 player program 52 deactivates the software audio decoding process, thereby stopping the deterrent sound.

A unique identifier value is programmed into non-volatile memory in each of collar unit 5 MCU 86. Bluetooth link 50 communication between sensor module 3 and collar unit 5 includes a unique identifier associated with a specific collar unit.

### Alternative Containment Embodiments

In another embodiment the wireless proximity sensing system incorporates medium-range Radio-Frequency Identification Device (RFID) components to determine the proximity of collar unit 5. Collar 5 includes a passive or active RFID tag and sensor module includes a RFID reader subsystem.

In another embodiment, deterrent sound is a recording of the animal 9 owner's voice expressing a command. In another embodiment deterrent sound is a voice recording of a speaker with tone and spoken word content that has been proven by testing to be effective in controlling animal behavior.

In one embodiment a smartphone app 36 is used to connect to proximity sensor module 3 via Bluetooth link 50 to control one or more of the following system parameters:
RSSI threshold setting (how close the animal can get to sensor module 5 before the deterrent sound is triggered)
selecting among a plurality of deterrent sounds
setting volume of deterrent sounds (setting parameter then sent to collar unit 5)
set a daily or weekly schedule for enabling or disabling system 1
recording and storage of animal 9 owner's voice commands to be used as a deterrent sound

### Alternative Containment Embodiment—Networked Sensor Module

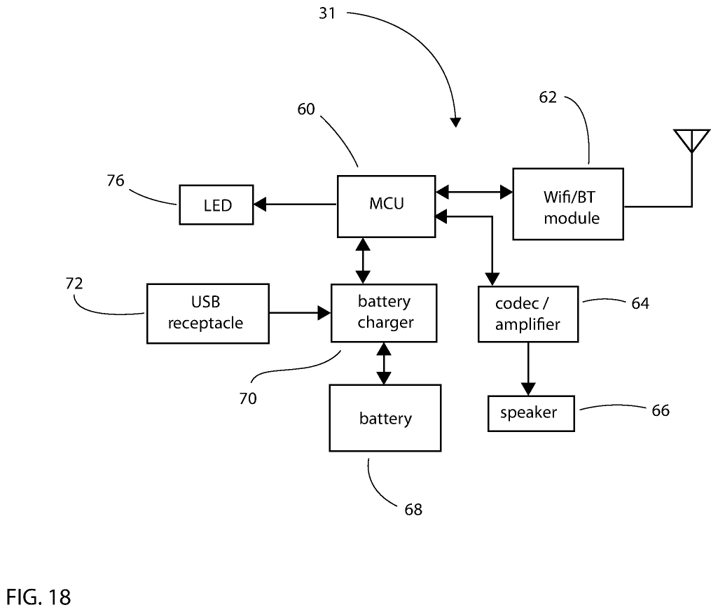

Referring now to FIG. 18, a block diagram shows that a networked proximity sensor module 31 includes a general purpose microcontroller (MCU) 60 that is a SAMD21 Cortex-MO+32-bit Low Power ARM MCU, and an RF communication module 62 that is Wifi-Bluetooth transceiver combination module model number NINA-W101 manufactured by u-blox, of Thalwil, Switzerland. Sensor module 31 also includes an audio amplifier-CODEC subsystem 64 and a speaker 66.

In one embodiment sensor module 31 includes a playback software application and is controlled and functions the same as collar unit 5—playing back audio according to scheduling or based on the location of the caregiver and the location of animal 9.

In another embodiment sensor module 31 receives playback instructions from setup and programming application 36 that specifies playback of soothing audio or deterrent audio specific to each of a plurality of collar units 5. Programming application 36 includes a software subroutine and a user interface for associating one or more of a sensor module 31 to one or more of a collar unit 5—using collar unit 5 unique identifier, and providing playback rule instructions based on proximity. For example a caretaker with multiple dogs specifies that when a first dog wearing first collar unit 5 moves within proximity range of first sensor module 31, a soothing sound is emitted from first collar unit 5. Continuing the example, the caretaker specifies that when a second dog wearing second collar unit 5 moves within proximity range of first sensor module 31, a deterrent sound is emitted from second collar unit 5. The caregiver also specifies that when a third dog wearing third collar unit 5 moves within proximity range of second sensor module 31, no sound is emitted from sensor module 31.

In an embodiment of setup and programming app 36 selecting the Name widget 190 shows an additional selection for adding a text name for each sensor module 31. Each unique name of a sensor module 31 is associated with a unique identifier stored in non-volatile memory in sensor module 31.

In one embodiment a playback message is sent directly from sensor module 31 to collar unit 5 via Bluetooth link 50. In another embodiment a playback control message is sent from sensor module 31 to collar unit 5 via Wifi link 34.

### Description of a Machine Vision Containment System

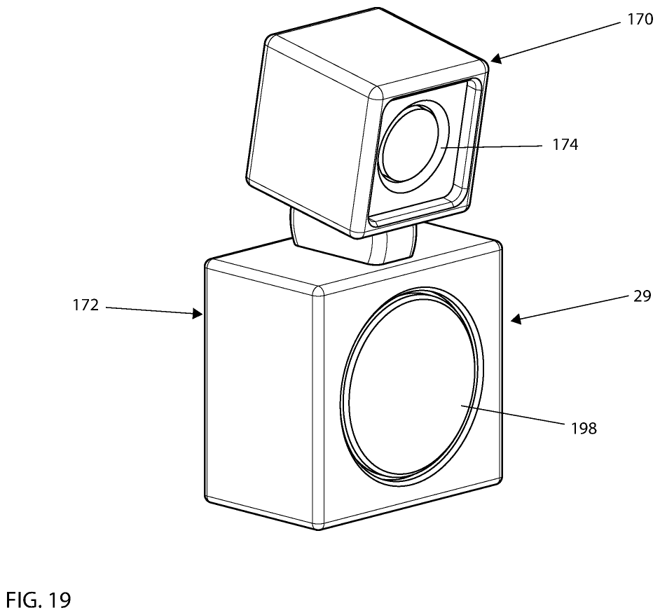

FIG. 19 shows a machine vision containment device 29 that includes a fixed focus camera 174 integral to a top camera module 170 pivotably connected to a base 172. Fixed focus camera 174 is electrically functionally connected to base 172 via a MIPI bus implemented in a flexible printed circuit that allows for the rotation of camera module 170 with respect to base 172. Base 172 includes an embedded video machine vision processing subsystem 58. In one embodiment machine vision processing subsystem 58 includes an i.MX8 microprocessor manufactured by NXP Semiconductors of Eindhoven, Netherlands, and related electrical components required to implement a functioning embedded processing circuit. In another embodiment embedded machine vision processing subsystem 58 is a Jetson Nano System-on-Module (SoM) developed and manufactured by Nvidia Corporation of Santa Clara, Calif.

Base 172 also includes a Wifi communication subsystem that is functionally connected to vision processing subsystem for connecting to Wifi networks that allow device 29 to connect to a smartphone 17 that is running a boundary setup smartphone app 186.

In another embodiment base 172 includes an optional audio amplifier connected to a speaker 198. Machine vision system 29 is powered by an AC-DC adapter (not shown). In one embodiment Wifi communications subsystem is part number LBWA1ZZ1HD manufactured by Murata Electronics of North America, Inc., located in Smyrna, Ga.

Machine vision containment device 29 processing subsystem 58 executes a recognizer software application 194 for recognizing one or more types of animals. Recognizer application 194 includes a canine image classifier that has been trained to recognize canines. Training image classifiers is a well-known process to software developers skilled in the art of machine and computer vision. In one embodiment a classifier is trained using the TensorFlow neural network computation library provide by Google, Inc. of Mountain View, Calif. The canine classifier is used by a recognizer software application 194 to analyze a specific image file, such as a JPEG image file, to determine if the image includes a canine. Recognizer software application 194 functions by periodically and continuously recording and analyzing images of the current scene. In one embodiment machine vision containment device 29 functions by recording and analyzing an image of the current scene once every ten seconds.

Machine vision containment device 29 also includes a controller software application 158 running on processing subsystem 58 that communicates with various other components in caretaker system 1 according to the various networking and communication configurations described herein.

In another embodiment the canine image analysis is performed on cloud server 23 that can execute multiple sessions of an animal recognizer software application 194, and base 172 includes a microcontroller subsystem, Wifi subsystem, and associated software that functions to periodically and continuously record images and send the images to the cloud server for analysis.

In another embodiment where a machine vision containment device includes an integrated motion detector, machine vision containment device enters a low power state until the motion detector is triggered. In one embodiment the motion sensor is part number AMG88 manufactured by Panasonic Industrial Devices Sales Company of America, located in Newark, N.J.

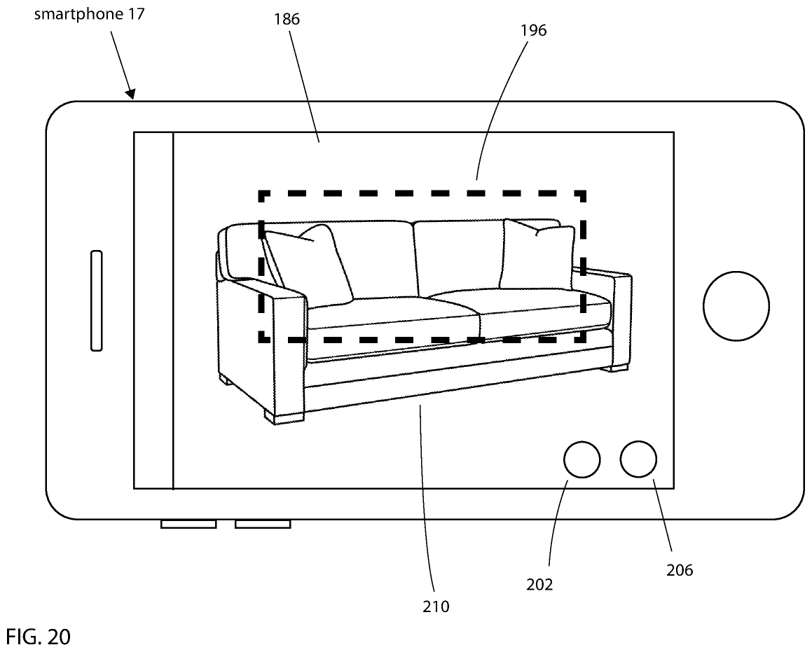

FIG. 20 shows a boundary setup app 186 user interface for setting up machine vision containment device 29. Recognizer software application 194 is in setup mode where containment device 29 is powered and transmitting video to smartphone 15 running boundary setup app 186. The user has placed containment device 29 on a stable surface and aims containment device 29 while viewing the video on smartphone 15. When the desired view is achieved, boundary setup app 186 includes a function for drawing, with a finger or stylus, one or more off-limit boundaries on smartphone 17 touch display. FIG. 20 shows an off-limits boundary 196 drawn around a sofa video image 210. Boundary setup app 186 includes two user interface control widgets, a delete boundary widget 202 and a save boundary widget 206. When the user selects the save boundary widget 206, the off-limit boundary data is sent to containment device 29 where recognizer software application correlates the boundary data to the scene image and stores the data in memory. Boundary setup app 186 also provides an interface for managing boundary zones that have been stored in memory—for example recalling a boundary zone or deleting a boundary zone.

### Machine Vision Containment System Function

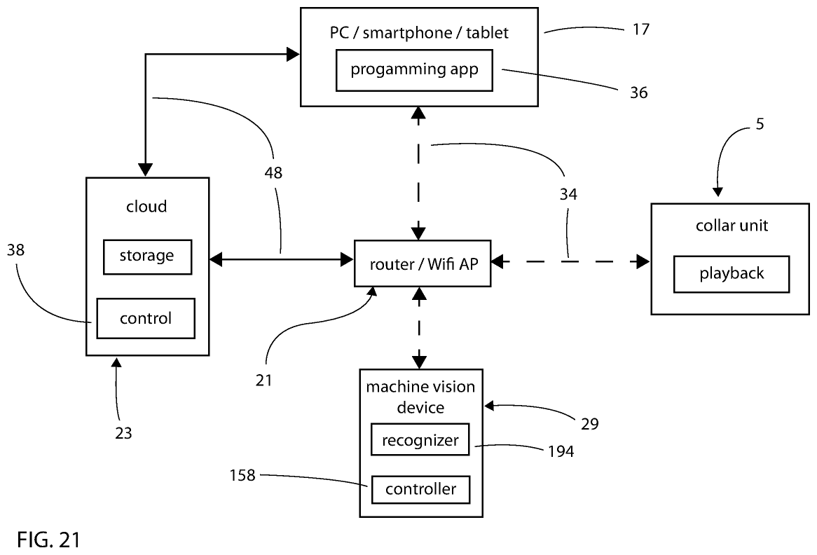

Referring to FIG. 21, when a canine 9 is recognized by classifier and is nearing or entering an off-limit boundary, controller application 158 sends a deterrent_event_start message to cloud server 23 which in turn sends a start_deterrent_sound message to collar device 5 via Wifi link 34. When the start_deterrent_sound message is received by collar device 5, collar device player 52 running on MCU 86 activates the software audio decoding process and a deterrent sound is emitted from speaker 114. Usually animal 9 moves in response to the deterrent sound. If animal 9 moves far enough away from the off-limit boundary as recognized by recognizer 194, controller software 158 functions to send a deterrent_event_stop message to cloud server 23, which in turn sends a stop_deterrent_sound to collar device 5. Upon receipt of stop_deterrent sound message, collar software program deactivates the software audio decoding process, thereby stopping the deterrent sound.

In another embodiment the deterrent action is a conventional high frequency sound emitted from containment device 29 speaker 198.

In another embodiment, deterrent sound is a recording of the animal's owner's voice expressing a command. In another embodiment the deterrent sound is a voice recording of a speaker with tone and content that has been proven by testing to be effective in controlling animal behavior.

### Alternative Embodiments—Machine Vision System

In another embodiment scene recognizer software application 194 includes one or more image classifiers for common household artifacts such as sofas, chairs, stairs, and doorways. Thus automatic setup is made possible by allowing the user to select a category of items, such as seating furniture, as off-limit zones using an automatic mode in the boundary setup app. Recognizer software application 194 running on embedded video machine vision processing subsystem 58 recognizes the specific artifacts and automatically creates off-limit boundaries (the user is not required to draw boundaries in the scene). In one embodiment recognizer software application 194 includes an interface for the user to approve, label, and edit the recognized artifact constructs that have been automatically recognized.

In another embodiment a classifier is trained for each of a plurality of canine breeds. In addition to pedigree recognizers, additional canine recognizers are trained for each of a variety of mixed breed dogs. A user interface in boundary setup app 186 allows the user to select one or more breeds for the system to recognize. In one mode the user interface shows a list the names of the pedigree breeds and mixed breeds. In another mode the user interface shows a list of pictures of the various breeds and mixed breeds. Boundary setup app 186 is configured to allow the user to select one or more breeds and/or mixed breeds to be recognized by tapping the name or image of the breed on smartphone 17 touch screen.

Recognizer software application 194 then applies the selected recognizer for each selected breed when the system is activated.

In another embodiment of recognizer software application 194 the plurality of canine breed recognizers is implemented in combination with furniture or other physical artifact recognizers to allow the user to set specific rules for each of their selected breeds and each of their selected furniture items. For example the user can specify that a dachshund should be prohibited from lying on a sofa, and a golden retriever is to be prohibited from climbing onto a rocking chair. Recognizer app 194 also provides a user interface for proving proper name labels to each of the caretaker's recognized animals.

Boundary setup app 186 running on a smartphone 17 therefore includes a user interface that provides a means for linking one or more canine breeds to one or more furniture items or household artifacts or features, such as doorway. The link is a logic function that specifies that the canine should not be allowed on or near the linked artifact or feature.

In another embodiment recognizer app 194 includes a software subroutine with logic that activates the playback of soothing audio on collar unit 5 when a recognized animal 9 is a specified distance from an off-limits object or area, and activates the playback of a deterrent sound on collar unit 5 when a recognized animal 9 is within an off-limits object or area.

In another embodiment recognizer app 194 receives playback instructions from setup and programming application 36 that specifies playback of soothing audio or deterrent audio specific to each of a plurality of collar units 5. Programming application 36 includes a software subroutine and a user interface for associating one or more of a recognized object or location to one or more of a collar unit 5—using collar unit 5 unique identifier, and providing playback rule instructions based on the proximity recognized by recognizer 194. For example a caretaker with multiple dogs specifies that when a first dog wearing first collar unit 5 moves within proximity range of a first recognized object, a soothing sound is emitted from first collar unit 5. Continuing the example, the caretaker specifies that when a second dog wearing second collar unit 5 moves within proximity range of a first recognized object, a deterrent sound is emitted from second collar unit 5. The caregiver also specifies that when a third dog wearing third collar unit 5 moves within proximity range of a first recognized location, no sound is emitted from sensor module 31.

### Identifying Sensor Modules and Collar Unit Devices

Setup and programming app 36 includes a software subroutine and user interface for physically identifying each of sensor module 3, sensor module 31, and collar unit 5 while using programming app 36. In one embodiment programming app 36 user interface includes a Device ID widget that is associated with a specific sensor module or collar unit, that when selected causes a specific LED flashing pattern on the device, for example three 0.2 second flashes followed by the LED off for 2 seconds. In another embodiment for use with sensor module 31 and collar unit 5, selecting the Device ID widget causes a sound to be played on the specific device, for example a 0.5 second tone.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for animal caretaking, comprising:
an audio playback device mounted on an animal, the playback device having a wireless communication subsystem, and a speaker,
an animal location sensing device in communication with the playback device,
a caretaker location sensing device in communication with the playback device,
where when the location of the caretaker is beyond a specified distance from a home base, a soothing sound is emitted from the playback device, and when the animal is a specified distance from the animal location sensing device, a deterrent sound is emitted from the playback device.

2. The animal caretaking system of claim 1 where the wireless communication system is Bluetooth and the location of the caretaker is determined by the loss of the Bluetooth link.

3. The animal caretaking system of claim 1 where the wireless communication system is Wifi and the location of the caretaker is determined by the loss of the Wifi link.

4. The animal caretaking system of claim 1 where the location of the caretaker uses a GPS coordinate.

5. The animal caretaking system of claim 1 where the soothing sound is randomly activated and deactivated.

6. The animal caretaking system of claim 1 where the audio playback device includes a motion sensing component for deactivating audio playback when a specific motion threshold is detected.

7. The animal caretaking system of claim 1 where the deterrent sound is high fidelity recording of the owner's voice.

8. A method for animal caretaking, comprising:
mounting an audio playback device with a wireless communication subsystem on an animal,
placing an animal location sensing device with a wireless communication subsystem in a location where the animal is prohibited,
the caretaker carrying a location sensing device,
activating playback of a soothing sound on the playback device when the caretaker is beyond a set distance from a home base, and activating a deterrent sound on the playback device when the animal is a set distance from the animal location sensing device.

9. The animal caretaking system of claim 1 where the wireless communication system is Bluetooth and the location of the caretaker is determined by the loss of the Bluetooth link.

10. The animal caretaking system of claim 1 where the wireless communication system is Wifi and the location of the caretaker is determined by the loss of the Wifi link.

11. The animal caretaking system of claim 1 where the location of the caretaker uses a GPS coordinate.

12. The animal caretaking system of claim 6 where the soothing sound is randomly activated and deactivated.

13. The animal caretaking system of claim 6 where the audio playback device includes a motion sensing component for deactivating audio playback when a specific motion threshold is detected.

14. The animal caretaking system of claim 1 where the deterrent sound is high fidelity recording of the owner's voice.
